(19) United States
(12) Patent Application Publication
(10) Pub. No.: US 2026/0337895 A1
(43) Pub. Date: Oct. 29, 2026

(54) ASPHALT/ASPHALT-EMULSION COATED AGGREGATE STONE MATERIAL FOR POTHOLE PATCHING AND METHODS OF MANUFACTURE

(71) Applicant: Benjamin Metcalf, Salisbury, CT (US)

(72) Inventor: Benjamin Metcalf, Salisbury, CT (US)

(21) Appl. No.: 19/658,473

(22) Filed: Apr. 25, 2026

Related U.S. Application Data
(60) Provisional application No. 63/795,294, filed on Apr. 26, 2025.

(51) Int. Cl. E01C 7/18; C08K 9/08; C08L 95/00; C09C 3/10; E01C 19/02

(52) U.S. Cl. CPC E01C 7/187; C08K 9/08; C08L 95/00; C09C 3/10; E01C 19/02; C01P 2004/60; C08K 2201/005; C08L 2555/52

(57) ABSTRACT

An aggregate stone material is provided for use in a pothole patching device. The aggregate stone material comprises aggregate stone and liquid asphalt. The aggregate stone may have a stone size of about ¼ in. The liquid asphalt is coated onto the aggregate stone wherein a ratio of liquid asphalt to aggregate stone is between about 0.75% and about 2% by weight, preferably about 1%. A method of producing the aggregate stone material in an asphalt plant is also provided wherein aggregate stone is heated, coated with asphalt, cooled, and then loosened by mechanical flipping. A method of producing the aggregate stone material in a pugmill is provided wherein the aggregate stone is combined with a liquid asphalt/antistrip blend at ambient temperature, dried, and loosened by mechanical flipping.

### CROSS-REFERENCE TO RELATED APPLICATIONS:

This application claims the benefit of U.S. Provisional Patent Application No. 63/795,294, filed Apr. 26, 2025, the entire disclosure of which is incorporated herein by reference.

### BACKGROUND OF THE DISCLOSURE

### (1) Field of the Invention

The instant invention relates to aggregate stone material for use in a pothole patching device.

### (2) Description of Related Art

Potholes in asphalt roadways are an inevitable end result of time, weather and wear. Regardless of a road's design and build quality, virtually all asphalt pavement will eventually crack, either from extreme cold, or dry, hot weather. Combined with heavy traffic, cracks eventually turn into larger potholes which in turn cause major damage to vehicles. Since prevention is an impossibility, management and timely repair becomes key.

There are numerous methods to repair potholes ranging from patch fillers to complete removal and replacement of entire pavement sections. Traditional hot-mix asphalt has always been the best option to return roads to near original condition. However, the drawback of hot-mix is that it must be kept at its optimum temperature at all times to remain usable. If hot-mix loses its ideal temperature, it becomes worthless and must be discarded. In the winter months, hot-mix is not available for paving or patching.

Pre-mixed aggregate, used in more basic patching techniques, is another viable option. However, it doesn't store well and isn't reusable. Any material left at the end of a workday ends up as waste. This can be a huge cost drain if workers improperly calculate material needs.

Another method, known as spray injection patching, has recently emerged as the choice method in terms of efficiency, quality and cost-effectiveness, and is now considered one of the most economical and longest lasting methods of pothole repair. Spray patching is done via a low-pressure air system, which delivers air, aggregate stone and a binding asphalt emulsion to the crack/hole for patching. Water, dirt and debris are removed from the pothole by blown air. The crack/hole is sealed with a coat of liquid asphalt emulsion to help ensure a strong bond between the aggregate mix and existing asphalt. The hole is then filled with a mix of asphalt emulsion and aggregate stone, which bonds to the existing pavement. Once filled, patch is sealed with a dry coat of aggregate stone to enhance durability and longevity.

The typical mix used in spray injection patching is a combination of aggregate and an asphalt emulsion and is a better choice over cold-mix in terms of patch quality and longevity. The mix allows a stronger, longer-lasting bond to be formed between the patch and existing asphalt. However, the asphalt emulsion spray patching systems are still not as effective as using conventional tar materials for strength and longevity. They are better than cold mix but not as good as hot mix.

In years past, municipalities and state transportation agencies would use conventional tar for road paving and repair applications. With the advent of more environmental considerations and regulations, these state entities are now being forced into using asphalt emulsions or water-based asphalt liquids to mix with aggregate stone material for pothole patching. However, while the liquid asphalt emulsions are effective under very good conditions (hot dry weather), their effectiveness is reduced when wet stone, damp surfaces or cold temperatures are present.

All of the above adverse conditions are prevalent during the winter, when the demand for pothole patching is most profound. Therefore, there is a need in the art for a pothole patching system including improved emulsion and aggregate stone material that are more effective under all conditions, and particularly in cold weather or wet conditions to ensure the pothole repair is durable and long-lasting.

### SUMMARY OF THE DISCLOSURE

According to exemplary embodiments of the invention, a novel aggregate stone material for use in a pothole patching device comprises aggregate stone which is pre-coated with liquid asphalt.

The aggregate stone has a stone size between about ⅛ in and about ⅜ in. The liquid asphalt is coated onto the aggregate stone, wherein a ratio of liquid asphalt to aggregate stone is between about 0.75% and about 2% by weight and the asphalt coated aggregate stone is dried after coating.

In some embodiments, the aggregate stone is coated at a temperature above 150 degrees Fahrenheit.

In some embodiments, the aggregate stone is coated at ambient temperature and the liquid asphalt further comprises an antistrip solution such that ratio of the antistrip solution to liquid asphalt is between about 0.015% and about 0.025% by volume.

In some embodiments, the liquid asphalt is an asphalt emulsion blend.

In some embodiments, the stone size of the aggregate stone is about ¼ in.

A first exemplary method of producing an aggregate stone material for use in a pothole patching device is provided wherein the aggregate stone material is produced by an asphalt plant. The method comprises providing aggregate stone having a stone size between about ⅛ in and about ⅜ in, heating the aggregate stone to eliminate moisture, and combining the heated aggregate stone with liquid asphalt to produce a coated aggregate stone. The liquid asphalt to aggregate stone ratio may be between 0.75% and 2% by weight. Once coated, the asphalt coated aggregate stone is allowed to cool and dry at ambient temperature. After drying, the dried, coated aggregate stone is flipped by a mechanical device to loosen the coated aggregate stone for use in a pothole patching device.

In some embodiments, heating the aggregate stone comprises heating the aggregate stone above 150 degrees Fahrenheit.

In some embodiments, the stone size of the aggregate stone is about ¼ in.

A second exemplary method of producing an aggregate stone material for use in a pothole patching device is provided wherein the aggregate stone material is produced by a pugmill at ambient temperature. The method comprises providing aggregate stone having a stone size between about ⅛ in and about ⅜ in, combining an antistrip solution with liquid asphalt to produce a liquid asphalt blend, and combining the aggregate stone with the liquid asphalt blend in a pugmill at ambient temperature to produce a coated aggregate stone. The antistrip solution overcomes the natural repulsion between the liquid asphalt and the wet stone and allows the asphalt blend to stick to the stone at ambient temperature. The liquid asphalt blend to aggregate stone ratio is between about 0.75% and about 2% by weight. Once coated, the asphalt blend coated aggregate stone is allowed to dry at ambient temperature and then flipped by a mechanical device to loosen the coated aggregate stone material for use in a pothole patching device.

In some embodiments, the stone size of the aggregate stone is about ¼ in.

In some embodiments, the liquid asphalt is an asphalt emulsion.

In some embodiments, the liquid asphalt blend has a ratio of antistrip solution to liquid asphalt between about 0.015% to about 0.025% by volume.

In some embodiments, the liquid asphalt blend to aggregate stone ratio is between about 1% and about 1.5% by weight.

While embodiments of the invention have been described as having the features recited, it is understood that various combinations of such features are also encompassed by particular embodiments of the invention and that the scope of the invention is limited by the claims and not the description.

### DETAILED DESCRIPTION OF THE EXEMPLARY EMBODIMENTS

The present disclosure provides formulations for, and methods of making and using, aggregate stone material for use in pothole patching applications. In particular, the formulations and methods allow for the production of aggregate stone material which can be applied via spray injection patching. The pre-coated aggregate stone material can be stored for extended lengths of time and mixed with an asphalt emulsion just before patching application which reduces waste in pothole patching operations.

Certain exemplary embodiments will now be described to provide an overall understanding of the principles of the structure, function, manufacture, and use of the composition and methods disclosed herein. Those skilled in the art will understand that the composition and methods specifically described herein are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure.

Unless otherwise specified, when referring to a numerical value, the term “about” is intended to be construed as including a range of values within +/−10% of the value being referenced.

According to some embodiments of the invention, a novel aggregate stone material has been developed for use in a pothole patching device. The aggregate stone material may generally comprise aggregate stone and liquid asphalt wherein the liquid asphalt is pre-coated onto the stone and functions as a binding agent during patching. The aggregate stone may have a stone size between about ⅛ in and about ⅜ in. In some embodiments, the stone size of the aggregate stone is about ¼ in. During manufacture, the liquid asphalt is coated onto the aggregate stone. The ratio of liquid asphalt to aggregate stone is between about 0.75% and about 2% by weight. In some embodiments, liquid asphalt to aggregate stone ratio is between about 1% and about 1.5% by weight. As an example, the aggregate stone material may require 10 lbs. of liquid asphalt for every 1000 lbs. of aggregate stone.

After the aggregate stone is coated with liquid asphalt, the material undergoes a drying process at ambient temperature. As one example, the aggregate stone material is placed into a temporary stockpile for cooling and drying. The coated aggregate material may slightly stick together and hardens as the asphalt coating dries. When it has dried, the coated aggregate stone material may be flipped by mechanical means, typically a loader equipped with a bucket. In flipping the material and dragging with the bucket, the bonds created between the stone by the dried liquid asphalt are broken creating a loose, asphalt coated aggregate stone material which flows the same as uncoated aggregate stone and can be used in the conventional prior art pothole patching machines.

The coated aggregate stone material has the benefit that it may be produced in either a traditional hot mix asphalt plant or a pugmill. If produced in an asphalt plant, the aggregate stone is heated before being coated by the liquid asphalt. In some embodiments, the aggregate stone is coated at a temperature above 150 degrees Fahrenheit. After the aggregate stone material is coated, the aggregate stone material undergoes a cooling and drying process. After cooling and drying, the asphalt coated stone is flipped and dragged to loosen the stone.

If the aggregate stone material is produced in a pugmill, the aggregate stone and the liquid asphalt may be combined at ambient temperature. Typically, aggregate stone at ambient temperature will contain some moisture when it is added to pugmill. Since the liquid asphalt will not stick well to wet stone, an antistrip solution may be added to the liquid asphalt. The antistrip solution overcomes the natural repulsion between the liquid asphalt and the wet stone and allows the asphalt/antistrip blend to more readily stick to the stone. The ratio of the antistrip solution to liquid asphalt is between about 0.015% and about 0.025% by volume. In some embodiments, the liquid asphalt may be an asphalt emulsion blend. Similarly, after the aggregate stone material is coated by the pugmill process, the aggregate stone material undergoes a cooling and drying process. After cooling and drying, the asphalt coated stone is flipped and dragged to loosen the stone.

In both methods of production, the coated aggregate stone material may be applied using a spray injection pothole repair process. The spray injection process combines the present coated aggregate stone material with an asphalt emulsion using a pothole patching device to apply the mix at high pressures. One type of known spray injection pothole patching devices are called “Durapatchers”.

A typical spray injection pothole repair process includes four steps: (1) cleaning the damaged area, (2) applying a tack coat, (3) injecting mixed aggregate/emulsion, and (4) applying a final layer.

First, the pothole or road surface crack is prepared for repair. A high-pressure air stream is used to remove loose debris, dirt, and moisture from the damaged area. A clean surface helps ensure that the repair patch adheres properly.

Second, a tack coat of liquid asphalt emulsion is applied to the pothole or crack. The tack coat acts a bonding agent between the road surface and the new asphalt patching mix comprising the present aggregate stone material and asphalt emulsion.

Third, the pothole patching device sprays a precise mix of asphalt emulsion and aggregate stone material into the damaged area. A high-pressure spray application compacts the material as it fills the hole or crack.

Fourth, a final layer of dry aggregate stone material is applied on top to prevent tracking.

The asphalt coated aggregate stone material offers numerous benefits over a traditional aggregate stone. Since the aggregate stone material is already coated with a liquid asphalt, the aggregate stone is chemically attracted to and will more readily mix with and adhere to the asphalt emulsion used in the pothole patcher, resulting in a much stronger patch.

As a result of the improved bonding with the coated aggregate stone material, the aggregate stone/emulsion mixture can be applied in lower temperatures than a traditional aggregate stone without an asphalt coating. An important consideration in the present invention is that the coated aggregate stone material flows freely like any other clean, dry stone making it suitable as a direct replacement for conventional uncoated aggregate stone while providing a significant improvement in patching strength and overall effectiveness.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. An aggregate stone material for use in a pothole patching device, the aggregate stone material comprising:
aggregate stone having a stone size between about ⅛ in and about ⅜ in; and
liquid asphalt coated onto the aggregate stone,
wherein a ratio of liquid asphalt to aggregate stone is between about 0.75% and about 2% by weight; and
wherein the asphalt coated aggregate stone is dried after coating.

2. The aggregate stone material of claim 1, wherein the aggregate stone is coated at a temperature above 150 degrees Fahrenheit.

3. The aggregate stone material of claim 1, further comprising an antistrip solution;
wherein a ratio of the antistrip solution to liquid asphalt is between about 0.015% and about 0.025% by volume; and
wherein the aggregate stone is coated at ambient temperature.

4. The aggregate stone material of claim 3, wherein the liquid asphalt is an asphalt emulsion blend.

5. The aggregate stone material of claim 1, wherein the stone size is about ¼ in.

6. The aggregate stone material of claim 2, wherein the stone size is about ¼ in.

7. The aggregate stone material of claim 3, wherein the stone size is about ¼ in.

8. The aggregate stone material of claim 4, wherein the stone size is about ¼ in.

9. The aggregate stone material of claim 5, wherein liquid asphalt to aggregate stone ratio is about 1% by weight.

10. The aggregate stone material of claim 6, wherein liquid asphalt to aggregate stone ratio is about 1% by weight.

11. The aggregate stone material of claim 7, wherein liquid asphalt to aggregate stone ratio is between about 1% and about 1.5% by weight.

12. The aggregate stone material of claim 8, wherein liquid asphalt to aggregate stone ratio is between about 1% and about 1.5% by weight.

13. A method of producing an aggregate stone material by asphalt plant for use in a pothole patching device, the method comprising:
providing aggregate stone having a stone size between about ⅛ in and about ⅜ in;
heating the aggregate stone;
combining the aggregate stone with liquid asphalt to produce a coated aggregate stone, wherein a liquid asphalt to aggregate stone ratio is between 0.75% and 2% by weight;
allowing the asphalt coated aggregate stone to dry at ambient temperature; and
flipping the coated aggregate stone by a mechanical device to loosen the coated aggregate stone for use in a pothole patching device.

14. The method of claim 13, wherein heating the aggregate stone comprises heating the aggregate stone above 150 degrees Fahrenheit.

15. The method of claim 13, wherein the stone size is about ¼ in.

16. A method of producing an aggregate stone material by pugmill for use in a pothole patching device, the method comprising:
providing aggregate stone having a stone size between about ⅛ in and about ⅜ in;
combining an antistrip solution with liquid asphalt to produce a liquid asphalt blend;
combining the aggregate stone with the liquid asphalt blend in a pugmill at ambient temperature to produce a coated aggregate stone, wherein a liquid asphalt blend to aggregate stone ratio is between 0.75% and 2% by weight;
allowing the asphalt blend coated aggregate stone to dry at ambient temperature; and
flipping the coated aggregate stone by a mechanical device to loosen the coated aggregate stone material for use in a pothole patching device.

17. The method of claim 16, wherein the stone size is about ¼ in.

18. The method of claim 16, wherein the liquid asphalt is an asphalt emulsion.

19. The method of claim 16, wherein a ratio of the antistrip solution to liquid asphalt is between about 0.015% to about 0.025% by volume.

20. The method of claim 17, wherein liquid asphalt blend to aggregate stone ratio is between about 1% and about 1.5% by weight.
